(19) United States
(12) Patent Application Publication
(10) Pub. No.: US 2017/0100800 A1
(43) Pub. Date: Apr. 13, 2017

(54) REPAIR METHOD FOR SEALING SEGMENTS

(71) Applicant: MTU Aero Engines AG, Munich (DE)

(72) Inventors: Uwe SCHULZE, Winsen (DE); Knut PARTES, Verden (DE)

(21) Appl. No.: 15/279,562

(22) Filed: Sep. 29, 2016

(30) Foreign Application Priority Data
Oct. 8, 2015 (DE) 102015219513.9

(51) Int. Cl. B23K 26/342; B23K 15/00; F01D 11/08

(52) U.S. Cl. CPC B23K 26/342; F01D 11/08; B23K 15/0086; F05D 2220/323; F05D 2230/80; F05D 2300/607; B23K 2201/001

(57) ABSTRACT

Disclosed is a method for repairing a sealing segments, formed at least partially in a monocrystalline fashion, of a flow channel wall of a turbomachine. At first a repair region of the sealing segment is established, independently of defects which may be present, and subsequently a part of a base material of the sealing segment is removed in the repair region. Subsequently a repair coating is deposited epitaxially in the repair region.

### CROSS-REFERENCE TO RELATED APPLICATIONS

The present application claims priority under 35 U.S.C. §119 of German Patent Application No. 102015219513, filed Oct. 8, 2015, the entire disclosure of which is expressly incorporated by reference herein.

### BACKGROUND OF THE INVENTION

1. Field of the Invention

The present invention relates to a method for repairing sealing segments, formed at least partially in a monocrystalline fashion, of a flow channel wall of a turbomachine.

2. Discussion of Background Information

In turbomachines, such as static gas turbines or aircraft engines, a rotor in the form of a rotating shaft having a multiplicity of rotor blades rotates relative to a stator, which is formed by the surrounding housing and guide vanes arranged thereon. In order to achieve a high efficiency, as far as possible all the working gas flowing through the machine should flow along the intended flow path between the guide vanes and the rotor blades. Correspondingly, it is expedient to avoid working gas being able to flow past the free ends of the guide vanes or rotor blades and the opposing machine parts moving relative thereto. Correspondingly, it is known to provide seals between the respective components, specifically in the form of so-called outer air seal or inner air seal, so that the least possible flow losses of working gas occur in the region of the free ends of guide vanes or rotor blades under all operating conditions. To this end, armoring or so-called sealing fins, together with running-in coatings into which the armoring or sealing fins can grind, are provided in the prior art, so that the flow losses can be kept as small as possible even in the event of variation of the gaps between the free ends of guide vanes and rotor blades and the opposing machine components during different operating conditions.

The outer air seal is conventionally arranged on so-called sealing segments of the inner shell of the housing, the sealing segments often being formed from a monocrystalline material in order to achieve better high-temperature strength by the monocrystalline configuration of the component. A plurality of sealing segments of the housing, or of an inner shell of the housing, may be arranged in succession circumferentially around the rotation axis of the turbomachine and axially next to one another, in order to form the inner wall of the flow channel.

Owing to the high thermal and mechanical stresses of the sealing segments, damage can take place because of pores and cracks, which may occur not only in a running-in coating of the sealing segments but also in the base material of the sealing segments. If the pores and cracks threaten the structural strength of the sealing segments, or if the running-in coating is worn by the passing rotor blades grinding in, the corresponding sealing segments with the running-in coatings need to be replaced, which may mean a high outlay and a material loss.

In view of the foregoing, it would be advantageous to have available a repair method with which sealing segments of turbomachines, such as static gas turbines or aircraft engines, can be repaired reliably, the repaired sealing segments being intended to have a lifetime which is as long as possible. At the same time, the repair method should be simple and reliable to carry out.

### SUMMARY OF THE INVENTION

The present invention provides a method for repairing a sealing segment of a flow channel wall of a turbomachine, which segment is formed at least partially in a monocrystalline fashion. The method comprises establishing a repair region of the sealing segment, independently of defects which may be present, and subsequently removing a part of a base material of the sealing segment in the repair region, followed by depositing a repair coating epitaxially in the repair region.

In one aspect of the method, the repair region may be defined by a rotor blade running region of the sealing segment, which region a rotor blade of the turbomachine passes over, or at least sweeps past in an imaginary radial extension of the rotor blade, during operation of the turbomachine. For example, the repair region may extend over the rotor blade running region, the repair region extending beyond the rotor blade running region by at most about 20%, e.g., at most about 10% of the extent of the rotor blade running region, in a direction which corresponds to the direction over which the repair region is widened beyond the rotor blade region, on each side where the repair region extends beyond the rotor blade region.

In another aspect of the method, a coating on the base material of the sealing segment, provided in the repair region, may be removed before a part of the base material is removed in the repair region.

In yet another aspect, the removal of material may be carried out mechanically by grinding and/or milling.

In a still further aspect, the removal of base material of the sealing segment may be carried out until no cracks or pores, or only cracks or pores with a diameter or a maximum extent less than or equal to a limit value according to permissible tolerances of a new sealing segment, are contained in the repair region in the base material.

In another aspect of the method, the repair coating may be formed by a repair material that is different from the base material and/or a repair material that is identical to the base material.

In another aspect, the repair coating may comprise a plurality of sublayers and/or the repair coating may be applied by a generative method, for example by deposition welding by high-energy beams such as laser beams and/or electron beams.

In another aspect of the method, the repair coating after application thereof may be shaped mechanically, e.g., by material removal.

As set forth above, the invention provides a repair method in which sealing segments, formed at least partially in a monocrystalline fashion, of a flow channel wall of a turbomachine, are repaired and refurbished in a particular predefined repair region. By virtue of the predetermined and defined repair region, which can as far as possible be established in the same way for all sealing segments which are the same or of the same type, it is possible to achieve a high process reliability and avoidance of repair defects. This applies, in particular, because the repair region is not restricted to individual defects to be identified, but is established generally for all sealing segments which are the same or of the same type, depending on the geometry and the shape of the sealing segment. The repair region therefore extends beyond the defects actually present.

Subsequently, in the defined repair region, a part of the base material of the sealing segment is removed and a repair coating is subsequently formed epitaxially on the monocrystalline base material in the repair region, so that the monocrystalline material of the base material is epitaxially replaced by the repair coating. Correspondingly, sealing segments formed at least partially in a monocrystalline fashion is intended to mean that at least the material of the base body of the sealing segment, or the base material, is formed in a monocrystalline fashion, while a possible running-in coating on the sealing segment need not be formed in a monocrystalline fashion.

The effect which can be achieved by the epitaxial formation of a repair coating on the base material is that there are identical, or at least similar, properties of the material in the repair coating in comparison with those of the base material. Although the epitaxial repair of monocrystalline workpieces, and in particular turbine blades, is already known (see EP 0 892 090 A1, EP 2 501 876 A1 or US 2011/0052386A1, the entire disclosures of which are incorporated by reference herein), nevertheless in the repair methods described therein, which have been used for components other than sealing segments, only locally damaged regions are repaired, which in the case of sealing segments may lead to distortion of the components because of the large-area and thin configuration of the sealing segments. Furthermore, such methods involving the identification of the locally existing defects are highly elaborate and entail the risk that not all defects will be repaired. By the definition according to the invention of a repair region, which is defined in such a way that, without specific identification of the local defects, it is assumed that the highest likelihood of defects exists in this region, uniform repair of the large-area sealing segments can be carried out with high process stability.

The repair region may for example be defined by the rotor blade running region of the sealing segment, which is in turn defined in that, in the rotor blade running region, the opposing rotor blades of the turbomachine pass over the sealing segment, or at least sweep past the sealing segment, or the running-in coating, in an imaginary radial extension of the rotor blades, during operation of the turbomachine. Such a repair region may be extended beyond the rotor blade running region, in order to provide a certain safety margin at the edges. For example, the repair region may extend beyond the rotor blade running region by at most about 20 percent, preferably by at most about 10 percent, of the extent of the rotor blade running region, in the direction in which the repair region is extended beyond the rotor blade region.

The removal of material from the sealing segment may be carried out by mechanical processing, and in particular material-removal processing such as grinding, turning or milling, this applying both for the removal of a coating provided on the base material of the sealing segment, for example a running-in coating, and for the base material.

The base material may be removed in the repair region until the pores or cracks can no longer be detected in the repair region. This may be established by visual inspection or by corresponding test methods during the processing, or between individual processing steps. Only cracks or pores with a diameter or a maximum extent which is less than or equal to a limit value can remain in the base material, since such defects can be healed during the epitaxial growth of a repair coating. Conventionally, the limit value may be selected in such a way that it corresponds to the diameter or the maximum extent which is tolerated in a new component after the casting of the material.

The repair coating may be formed from the same material which, as a base material, forms the base body of the sealing segment. As an alternative, it is also possible to use similar materials which, in particular, have the same lattice structure with similar lattice constants, so that an almost monocrystalline bond between the base material and the repair coating is possible. The repair coating may be constructed from a plurality of sublayers, even different sublayers, and may in particular be formed by generative methods such as deposition welding or electron-beam welding.

The repair coating may be applied with an overdimension, since after the application of the repair coating it may be subjected to mechanical shaping, for example by material-removal processing.

### BRIEF DESCRIPTION OF THE DRAWINGS

In the appended drawings, purely schematically

FIG. 1 shows a partial section through a turbomachine with a guide vane and rotor blade pair,

FIG. 2 shows a cross section through a sealing segment,

FIG. 3 shows a plan view of a sealing segment, and

FIG. 4 shows in Subfigures a) to f) the various method steps of an exemplary embodiment of the repair method according to the invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

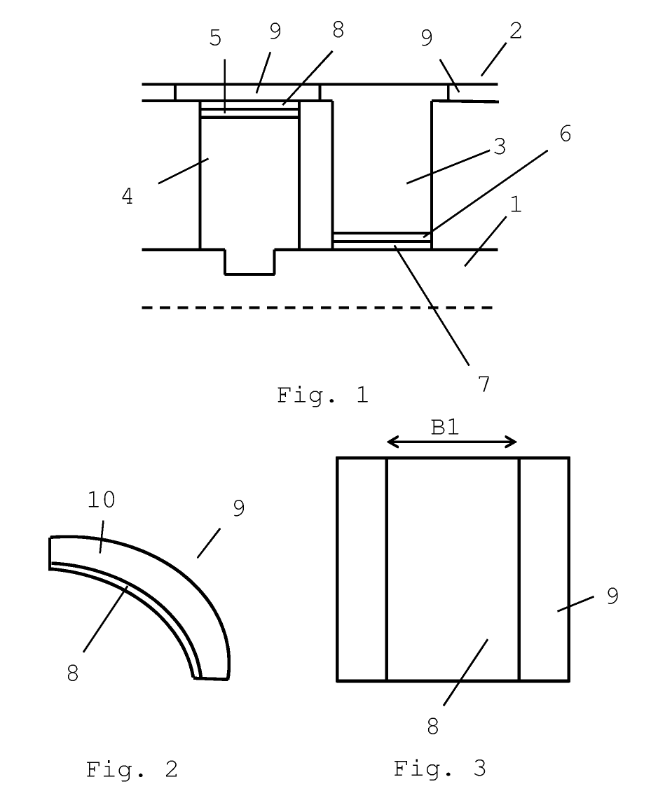

FIG. 1 shows a partial section through a turbomachine, for example an aircraft engine, having a shaft 1 that is enclosed annularly by a housing 2, although only a part above the symmetry line or rotation axis (represented by dashes) of the shaft 1 is shown in FIG. 1. A multiplicity of rotor blades 4 are arranged circumferentially around the shaft 1 next to one another in a rotor blade row, and in a plurality of rotor blade rows, on the shaft 1, only one rotor blade row having a rotor blade 4 being shown in FIG. 1. Arranged next to the rotor blade 4, there is a guide vane 3 which is fastened on the housing 2, a plurality of rotor blades in turn being arranged circumferentially around the rotation axis next to one another in a plurality of rotor blade rows. The guide vanes 3 are connected in a fixed manner to the housing 2, while the rotor blades 4 rotate with the shaft 1 during rotation of the latter.

The housing 2, which has a cylindrical base shape in the highly simplified representation of FIG. 1, may be constructed from a multiplicity of components, and in particular from an outer and inner shell. The components of the inner shell, which are exposed to high temperatures by the gas flowing past, may be at least partially formed from monocrystalline material so as to thus provide sufficient strength at high temperatures.

The housing 2 may comprise a plurality of sealing segments 9, which may be arranged successively as housing components circumferentially around the rotation axis of the turbomachine and next to one another in the axial direction. In FIG. 1, only cross sections of a few segments 9 can be seen for the sake of simplicity.

In order to avoid flow losses between the housing 2 and the tips of the rotor blades 4 on the one hand, and the free ends of the guide vanes 3 and the shaft 1 on the other hand, so-called seals are arranged in these regions, specifically on the one hand a so-called outer air seal in the region of the tips of the rotor blades 4 and an inner air seal in the region of the free ends of the guide vanes 3. The outer air seal is arranged on a corresponding sealing segment 9.

The seals respectively consist of sealing pairs matched to one another, for example a tip armoring 5 on the free ends of the rotor blades 4 with a so-called running-in coating 8, which is arranged opposite the free ends of the rotor blades 4 on the sealing segment 9 of the housing 2.

Since the gap between the free ends of the rotor blades 4 and the housing 2 may vary depending on the operating conditions, the corresponding seal is configured in such a way that tip armoring 5 grinds onto the running-in coating 8, or grinds into it, in order to ensure optimal sealing. Correspondingly, so-called sealing fins (not shown) may be provided on the tip armoring 5, which fins are each formed as protruding webs and grind defined grooves into the running-in coating 8.

Correspondingly, armoring 6 with a running-in coating 7 may also be provided at the so-called inner air seal, in which case the arrangement of the armoring 6 and the running-in coating 7 may he carried out optionally on the rotor, i.e. the shaft 1, or the stator, i.e. the guide vane 3. This also applies for the outer air seal.

FIG. 2 shows a sealing segment 9 in cross section. The sealing segment 9 comprises a body made of a base material 10, on which the running-in coating 8 is arranged. FIG. 3 shows the sealing segment 9 in a plan view.

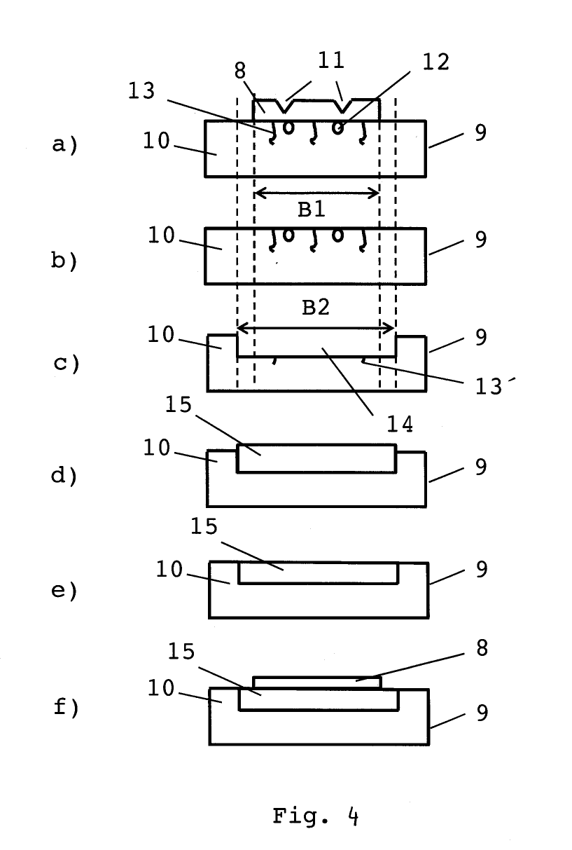

The sealing segment is shown in cross section in FIG. 4, the various repair steps of the repair method according to the invention being shown in the Subfigures a) to f). Subfigure a) of FIG. 4 shows the starting state of a worn sealing segment 9, in which two grooves 11, which are caused for example by sealing fins of a corresponding rotor blade 4, are ground into the running-in coating 8.

Because of the thermal load of the sealing segment during operation, and the resulting diffusion processes inside the material, pores 12 have been formed, which may be present both in the running-in coating 8 and in the base material 10. Furthermore, the thermomechanical loading of the sealing segment 9 has given rise to damage by cracks 13, which may likewise be present both in the running-in coating 8 and in the base material 10. In the sealing segment 9 shown in FIG. 3 and FIG. 4, the width B1 of the running-in coating 8 corresponds to the rotor blade running region, which is defined by the rotor blades 4 passing over or grinding in on the sealing segment.

Subfigure b) of FIG. 4 shows the state after removal of the running-in coating 8. The running-in coating 8 may, for example, be ground or milled off from the sealing segment 9.

In addition, base material 10 is removed in a repair region, which has the width B2 that is greater than the width B1 of the running-in coating 8, or of the rotor blade running region, in which case suitable mechanical processing methods such as milling or grinding may again be used.

In the repair region 14, enough base material 10 is removed so that as far as possible all pores 12 and cracks 13 are removed. Only small-dimensioned residues of cracks 13 and/or pores (not shown), which can be healed by the subsequent epitaxial deposition of a repair coating 15 onto the monocrystalline base material 10, may remain in the base material 10, as is shown in FIG. 4c).

After removal of the running-in coating 8 and of the base material 10 in the repair region 14, a repair coating 15 is applied in this region by a generative method, for example deposition welding, the application being carried out in such a way that the material of the repair coating 15 grows epitaxially on the monocrystalline base material 10, so that, when the same material is used for the repair coating 15 as for the base material 10, a monocrystalline body is formed. When a different material to the base material 10 is used for the repair coating 15, a material will be selected which has a similar lattice structure and similar lattice constants, so that a quasi-monocrystalline structure can be formed by the epitaxial growth.

As can be seen in Subfigure d) of FIG. 4, the repair coating 15 may be applied with an overdimension, since mechanical shaping of the repair coating 15, during which excess material of the repair coating 15 is removed by material-removal processing, is subsequently carried out. The corresponding result is represented in Subfigure e) of FIG. 4. A running-in coating 8 may in turn be provided on a correspondingly repaired base body of the sealing segment 9, as is represented in Subfigure f) of FIG. 4, so that, after the repair, an entirely new sealing segment 9 is provided, which has a running-in coating 8 and can be used again in the turbomachine.

Although the present invention has been described in detail with the aid of the exemplary embodiment, it is clear to the person skilled in the art that the invention is not restricted to this exemplary embodiment, and rather that variants are possible in that individual features may be omitted or different combinations of features may be implemented, so long as the protective scope of the appended claims is not departed from. In particular, the present disclosure comprises all combinations of the proposed individual features.

### DEFINITIONS

In the present description, axial and radial directions refer to the rotation axis of the turbomachine, so that an axial direction is intended to mean the direction in which the rotation axis of the turbomachine extends, while a radial direction is intended to mean the direction which extends away from the rotation axis.

### LIST OF REFERENCE NUMBERS

1 shaft
2 housing
3 guide vane
4 rotor blade
5 armoring
6 armoring
7 running-in coating
8 running-in coating
9 sealing segment
10 base material or base body
11 running-in groove
12 pore
13 crack
14 repair region
15 repair coating

What is claimed is:

1. A method for repairing a sealing segment, formed at least partially in a monocrystalline fashion, of a flow channel wall of a turbomachine, wherein the method comprises establishing a repair region of the sealing segment, independently of defects which may be present, and subsequently removing a part of a base material of the sealing segment in the repair region, followed by depositing a repair coating epitaxially in the repair region.

2. The method of claim 1, wherein the repair region is defined by a rotor blade running region of the sealing segment, which region a rotor blade of the turbomachine passes over, or at least sweeps past in an imaginary radial extension of the rotor blade, during operation of the turbomachine.

3. The method of claim 2, wherein the repair region extends over the rotor blade running region, the repair region extending beyond the rotor blade running region by at most about 20% of the extent of the rotor blade running region, in a direction which corresponds to a direction over which the repair region is widened beyond the rotor blade region, on each side where the repair region extends beyond the rotor blade region.

4. The method of claim 2, wherein the repair region extends over the rotor blade running region, the repair region extending beyond the rotor blade running region by at most about 10% of the extent of the rotor blade running region, in a direction which corresponds to a direction over which the repair region is widened beyond the rotor blade region, on each side where the repair region extends beyond the rotor blade region.

5. The method of claim 1, wherein a coating on the base material of the sealing segment, provided in the repair region, is removed before a part of the base material is removed in the repair region.

6. The method of claim 1, wherein removal of material is carried out mechanically by grinding and/or milling.

7. The of claim 1, wherein removal of base material of the sealing segment is carried out until no cracks or pores, or only cracks or pores with a diameter or a maximum extent less than or equal to a limit value according to permissible tolerances of a new sealing segment, are contained in the repair region in the base material.

8. The method of claim 1, wherein the repair coating is formed by a repair material different from the base material and/or a repair material identical to the base material.

9. The method of claim 8, wherein the repair coating comprises a repair material different from the base material.

10. The method of claim 8, wherein the repair coating comprises a repair material identical to the base material.

11. The method of claim 1, wherein the repair coating comprises a plurality of sublayers.

12. The method of claim 1, wherein the repair coating is applied by a generative method.

13. The method of claim 12, wherein the repair coating is applied by deposition welding by high-energy beams.

14. The method of claim 13 wherein the high-energy beams comprise laser beams.

15. The method of claim 13 wherein the high-energy beams comprise electron beams.

16. The method of claim 1, wherein the repair coating after application thereof is shaped mechanically.

17. The method of claim 1, wherein the repair coating after application thereof is shaped by material removal.

18. The method of claim 8, wherein the repair coating comprises a plurality of sublayers.

19. The method of claim 9, wherein the repair coating comprises a plurality of sublayers.

20. The method of claim 10, wherein the repair coating comprises a plurality of sublayers.
